(19) United States
(12) Patent Application Publication
(10) Pub. No.: US 2019/0249731 A1
(43) Pub. Date: Aug. 15, 2019

(54) ABUTMENT CLIP FOR DISK BRAKES

(71) Applicant: MANDO CORPORATION, Gyeonggi-do (KR)

(72) Inventors: Antonio Eduardo DEMORAIS, Novi, MI (US); Daniel Alan Smith, White Lake, MI (US)

(21) Appl. No.: 15/893,582

(22) Filed: Feb. 9, 2018

(51) Int. Cl. F16D 65/092; F16D 55/22; B60T 1/06

(52) U.S. Cl. CPC F16D 65/092; F16D 2125/582; B60T 1/065; F16D 55/22

(57) ABSTRACT

A brake clip is described. The brake clip can include a U-shaped body; a clip channel; and a return spring, wherein the clip channel is defined by: a clip base comprising a stop tab; a pad tensioner; and the channel side tab; wherein, the clip base is connected to the pad tensioner and the channel side tab to form a channel; the return spring is connected to the clip channel at a rotor side edge of the clip channel and extends over the clip base; the clip channel is configured to fit into a channel on the brake pad carrier and to receive a brake pad; and the stop tab extends into the clip channel and is configured to press on a brake pad backing plate when a portion of the brake pad backing plate is located in the clip channel.

### TECHNICAL FIELD

This disclosure relates to brake systems and interfaces for the brake pad to the rest of the brake system, such as abutment clips located between a brake pad and a brake pad carrier.

### BACKGROUND

Disk brake systems on vehicles, such as disk brake systems on cars, can include a friction material on a brake pad that rubs against a brake rotor to slow or stop the vehicle. Disk brakes can be installed to operate on one or more or all wheels of a vehicle, such as the front wheels, the back wheels, or both front and back wheels.

The brake pads can be installed in a caliper assembly, where a hydraulic or otherwise actuated piston forces the brake pad against the rotor during actuation of the brake. When the brake is not being actuated, it is desirable for the brake pad to be spaced apart from the rotor at least to prevent unnecessary wear to the brake pad. While brake systems frequently include at least some measures to assist in retracting the brake pad from the rotor when the brake system is deactuated, it can be desirable to provide additional measures to assist in retracting the brake pad such as to increase the responsiveness of the brake or to provide greater assurance of brake release.

In addition, when the brake assembly is in the deactuated state, the brake pad is not clamped tightly by the piston and caliper assembly against the rotor. In this deactuated state, the brake pad must still be held securely by the brake assembly, but because the brake pad must also be allowed to move in relation to various brake assembly components during actuation, there is a risk of the brake pad moving within the holding mechanism for the brake pad, such as when the vehicle is subjected to bumps or vibration such as during operation on a roadway. This movement of the brake pad can in some cases cause rattles or other noises during vehicle operation. Generally, such noises are undesirable as they can lead to discomfort for the occupants of the vehicle and/or concerns regarding malfunction or failure of vehicle components.

In some vehicles, a brake clip can be provided as an interface between the brake pad and the rest of the disk brake assembly, such as between the brake pad and a brake pad carrier.

A brake clip can act to provide a spring action to provide a tighter fit and to preload a resisting force against movement of the brake pad within the brake pad assembly than might be possible otherwise, and which can in some cases reduce rattle or vibration. Accordingly, it is desirable to provide a brake clip that can reduce rattle or vibration or assist in retracting the brake pad from the rotor when the brakes are deactuated.

### SUMMARY

In a first aspect disclosed herein a brake clip is provided, the brake clip comprising a U-shaped body; a clip channel; and a return spring, wherein the U-shaped body comprises: a guide anchor top; a side tab; a front tab; an inner axial tab; a channel side tab; and an inner axial tab, and the side tab, front tab, inner axial tab and channel side tab extend from respective edges of the guide anchor top, forming a pocket; the clip channel defined by: a clip base comprising a stop tab; a pad tensioner; and the channel side tab; wherein, the clip base is connected to the pad tensioner and the channel side tab to form a channel; the return spring is connected to the clip channel at a rotor side edge of the clip channel and extends over the clip base; the pocket is configured to receive an inboard guide of a brake pad carrier with the front tab, inner axial tab, channel side tab, and side tab contacting a front, inner axial, channel side and side face of the inboard guide, respectively; the clip channel is configured to fit into a channel on the brake pad carrier and to receive a brake pad; and the stop tab extends into the clip channel and is configured to press on a brake pad backing plate or retain a brake pad backing plate between the stop tab and the return spring when a portion of the brake pad backing plate is located in the clip channel.

In a second aspect disclosed herein is a disk brake assembly, the disk brake assembly comprising a brake clip, the brake clip comprising a U-shaped body; a clip channel; and a return spring, wherein the U-shaped body comprises: a guide anchor top; a side tab; a front tab; an inner axial tab; a channel side tab; and an inner axial tab, and the side tab, front tab, inner axial tab and channel side tab extend from respective edges of the guide anchor top, forming a pocket; the clip channel defined by: a clip base comprising a stop tab; a pad tensioner; and the channel side tab; wherein, the clip base is connected to the pad tensioner and the channel side tab to form a channel; the return spring is connected to the clip channel at a rotor side edge of the clip channel and extends over the clip base; the pocket is configured to receive an inboard guide of a brake pad carrier with the front tab, inner axial tab, channel side tab, and side tab contacting a front, inner axial, channel side and side face of the inboard guide, respectively; the clip channel is configured to fit into a channel on the brake pad carrier and to receive a brake pad; and the stop tab extends into the clip channel and is configured to press on a brake pad backing plate when a portion of the brake pad backing plate is located in the clip channel, and the disk brake assembly further comprising a brake pad carrier comprising the channel and the inboard guide; and a brake pad comprising the backing plate, wherein the clip channel is present in the channel, and the inboard guide is present in the pocket, and the return spring contacts the backing plate, wherein, upon actuation of the brake assembly, the brake pad moves within the channel against the return spring, the return spring providing a restoring force against the brake pad upon deactuation of the brake assembly to assist in moving the brake pad away from the rotor-edge of the clip channel.

In a third aspect disclosed herein a brake clip is provided, the brake clip comprising a pad tensioner attached to a clip base attached at an edge to a pad tensioner and at an opposite edge to channel side tab to form a clip channel; a guide anchor top attached at an edge to the channel side tab and at an opposite edge to a side tab to form a U-shaped body extending from a rotor side edge to an outer edge; a return spring extending from a rotor side edge of the clip channel over the clip base; and a stop tab extending from the clip base into the clip channel.

In a fourth aspect disclosed herein a brake assembly is provided, the brake assembly comprising a brake clip, the brake clip comprising a pad tensioner attached to a clip base attached at an edge to a pad tensioner and at an opposite edge to channel side tab to form a clip channel; a guide anchor top attached at an edge to the channel side tab and at an opposite edge to a side tab to form a U-shaped body extending from a rotor side edge to an outer edge; a return spring extending from a rotor side edge of the clip channel over the clip base; and a stop tab extending from the clip base into the clip channel, the brake assembly further comprising a brake pad carrier comprising a first channel and a first inboard guide; and a first brake pad comprising a first backing plate, wherein the clip channel for the brake clip is present in the first channel, and the first inboard guide is present in the clip channel of the brake clip, and the return spring of the brake clip contacts the backing plate, wherein, upon actuation of the brake assembly, the first brake pad moves within the clip channel of the first brake clip against the return spring of the first brake clip, the return spring of the first brake clip providing a restoring force against the first brake pad upon deactuation of the brake assembly to assist in moving the first brake pad away from the rotor-edge of the U-shaped body of the first brake clip.

In a first embodiment of the fourth aspect, the brake assembly further comprises a second brake pad comprising a second backing plate; a second, third and fourth brake clip, each of the first, second, third and fourth brake clip having a pad tensioner attached to a clip base attached at an edge to a pad tensioner and at an opposite edge to channel side tab to form a clip channel; a guide anchor top attached at an edge to the channel side tab and at an opposite edge to a side tab to form a U-shaped body extending from a rotor side edge to an outer edge; a return spring extending from a rotor side edge of the clip channel over the clip base; and a stop tab extending from the clip base into the clip channel, the brake assembly further comprising a brake pad carrier comprising a first channel and a first inboard guide; and a first brake pad comprising a first backing plate, wherein the clip channel for the brake clip is present in the first channel, and the first inboard guide is present in the clip channel of the brake clip, and the return spring of the brake clip contacts the backing plate, wherein, upon actuation of the brake assembly, the first brake pad moves within the clip channel of the first brake clip against the return spring of the first brake clip, the return spring of the first brake clip providing a restoring force against the first brake pad upon deactuation of the brake assembly to assist in moving the first brake pad away from the rotor-edge of the U-shaped body of the first brake clip; wherein the brake pad carrier comprises a first arm and a second arm, each arm having a first brake abutment position and a second abutment position, the first brake abutment position of the first arm comprising: the first channel and the first inboard guide; the second brake abutment position of the first arm comprising: a second channel and a second inboard guide; the first brake abutment position of the second arm comprising: a third channel and a third inboard guide; and the second brake abutment position of the second arm comprising: a fourth channel and a fourth inboard guide; wherein, the U-shaped body for the second brake clip is present in the second channel, and the second inboard guide is present in the clip channel of the second brake clip, and the return spring of the second brake clip contacts the backing plate of the first brake pad; U-shaped body for the third brake clip is present in the third channel, and the third inboard guide is present in the clip channel of the third brake clip, and the return spring of the third brake clip contacts the second backing plate; and U-shaped body for the fourth brake clip is present in the fourth channel, and the fourth inboard guide is present in the clip channel of the fourth brake clip, and the return spring of the fourth brake clip contacts the second backing plate; wherein, upon actuation of the brake assembly, the first brake pad moves within the U-shaped bodies of the first and second brake clips against the return springs of the first and second brake clips, the return springs of the first and second brake clips providing a restoring force against the first brake pad upon deactuation of the brake assembly to assist in moving the first brake pad away from the rotor-edge of the U-shaped bodies of the first and second brake clips, and the second brake pad moves within the U-shaped bodies of the third and fourth brake clips against the return springs of the third and fourth brake clips, the return springs of the third and fourth brake clips providing a restoring force against the second brake pad upon deactuation of the brake assembly to assist in moving the second brake pad away from the rotor-edge of the U-shaped bodies of the third and fourth brake clips.

In a fifth aspect disclosed herein a brake clip is provided, the brake clip comprising a brake clip base; a stop tab extending from the brake clip base; and a brake pad return spring, the brake pad return spring comprising: a proximal end attached to an edge of the brake clip base, the edge of the brake pad base when installed is proximate a brake rotor; and a distal end extended over the brake clip base, wherein when the brake clip is installed in a brake system, the distal end is configured to contact and exert a force against a brake pad and the stop tab is configured to contact the brake pad.

In a sixth aspect disclosed herein, a brake kit is provided, the brake kit comprising: four brake clips, each brake clip comprising a pad tensioner attached to a clip base attached at an edge to a pad tensioner and at an opposite edge to channel side tab to form a clip channel; a guide anchor top attached at an edge to the channel side tab and at an opposite edge to a side tab to form a U-shaped body extending from a rotor side edge to an outer edge; a return spring extending from a rotor side edge of the clip channel over the clip base; and a stop tab extending from the clip base into the clip channel.

In a seventh aspect disclosed herein a brake clip is provided, the brake clip comprising: a brake clip base; a stop tab extending from the brake clip base; and a brake pad return spring, the brake pad return spring comprising: a proximal end attached to an edge of the brake clip base, the edge of the brake pad base when installed is proximate a brake rotor; and a distal end extended over the brake clip base, wherein when the brake clip is installed in a brake system, the distal end is configured to contact and exert a force against a brake pad and the stop tab is configured to contact the brake pad.

In an eighth aspect disclosed herein a brake kit is provided, the brake kit comprising four brake clips, each brake clip comprising: a pad tensioner attached to a clip base attached at an edge to a pad tensioner and at an opposite edge to channel side tab to form a clip channel; a guide anchor top attached at an edge to the channel side tab and at an opposite edge to a side tab to form a U-shaped body extending from a rotor side edge to an outer edge; a return spring extending from a rotor side edge of the clip channel over the clip base; and a stop tab extending from the clip base into the clip channel; the brake kit further comprising two brake pads, each brake pad comprising first and second ends, wherein each of the first and second ends are sized and configured to fit into the clip channel of at least one of the four brake clips.

### BRIEF DESCRIPTION OF THE DRAWINGS

FIG. 1 shows an exploded view of an embodiment of a disk brake assembly with a brake pad carrier, a brake pad and a brake clip.

FIG. 2 shows an embodiment of a brake clip.

FIG. 3 shows another view of an embodiment of a brake clip.

FIG. 4 shows two embodiments of a disk brake assembly with a brake pad carrier, a brake pad and a brake clip.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

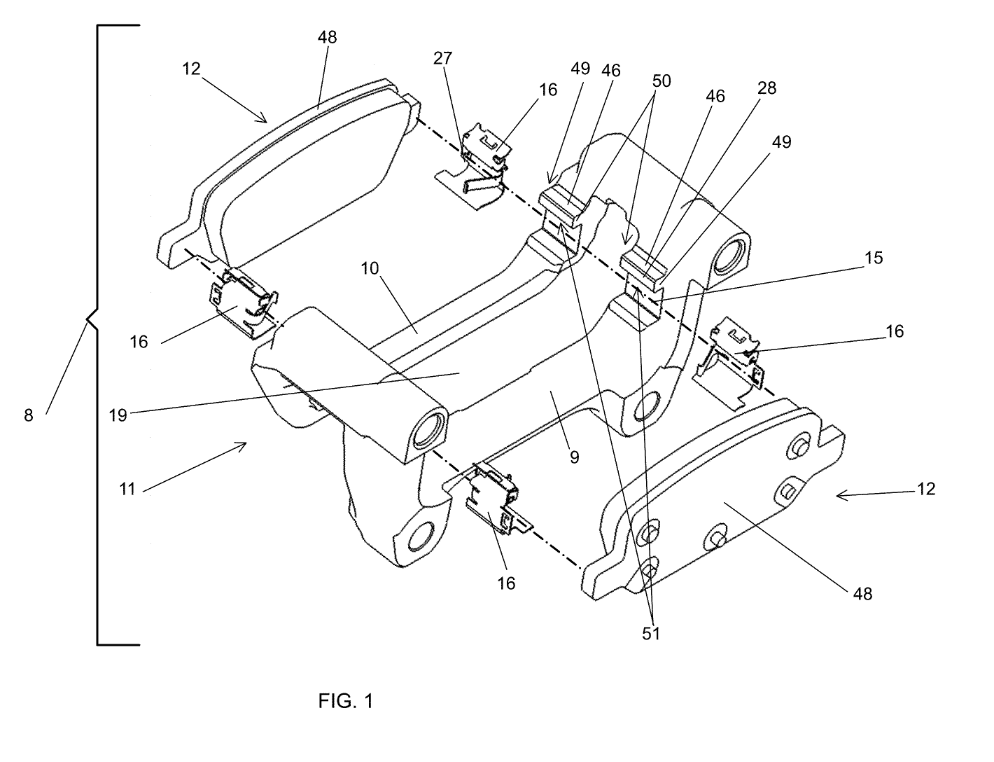

FIG. 1 shows an embodiment of a brake assembly 8 where a brake clip 16 is positioned in a brake pad carrier 11 of a disk brake system. In some embodiments, the brake pad carrier 11 can be integrated into other parts of the brake system, such as a caliper housing, such that the brake clips 16 and brake pads are attached to the caliper housing. The brake pad carrier 11 of FIG. 1 utilizes four brake clips 16 which interface with two brake pads 12 and the brake pad backing plates 48, with two brake clips 16 and one brake pad 12 associated with an inner arm 9 and two brake clips 16 and one brake pad 12 associated with an outer arm 10. For reference, the inner arm 9 can be viewed as being mounted on a vehicle (not shown) closer to the centerline (not shown) of the vehicle than the outer arm 10. Between the inner arm 9 and the outer arm 10 is a rotor space 19, where a brake rotor (not shown) would be located when the brake assembly 8 is positioned on a vehicle. Brake clip 16 has a rotor side edge 26 proximal the rotor space 19 and a non-rotor side edge 27 distal the rotor space 19, and a U-shaped body 44 that fits over a guide 28 and into a channel 15 on the brake pad carrier 11. In some embodiments, the guide 28 can be a protrusion such as a post or a rail or a rectangular protrusion from the brake pad carrier configured, for example, to form a portion of the channel 15.

As discussed above, FIG. 1 shows four brake clips 16 associated with the brake pad carrier 11. However, in some embodiments, two of the brake clips 16 can be connected together effectively forming a combined brake clip. Such a combined brake clip can combine the functionality and features of one brake clip 16 of the inner arm 9 and one brake clip 16 of the outer arm 10, resulting in only two clips being used.

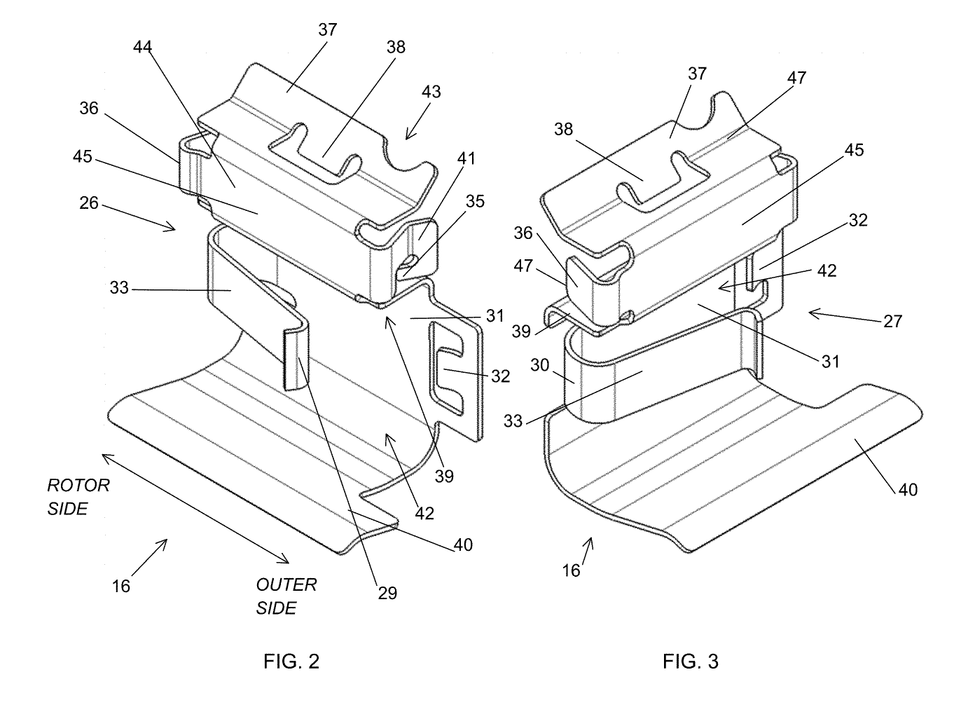

FIG. 2 shows an embodiment of brake clip 16. Here, a clip base 31 is connected along one edge to an edge of a pad tensioner 40, and along an opposite edge to a channel side tab 39. As shown in FIG. 2, the pad tensioner 40, clip base 31 and channel side tab form a clip channel 42. The channel side tab 39 is connected at another edge to a guide anchor top 45 which is in turn connected to a side tab 37. In some embodiments, the channel side tab 39, guide anchor top 45 and side tab 37 can form a clip channel 42. As depicted in FIGS. 2 and 4, the U-shaped body 44 and the clip channel 42 can have openings for receiving a guide 28 and a brake pad 12, respectively, that open in opposite directions.

In some embodiments, the clip channel can have a front tab 41 located at the non-rotor side edge 27 which at least partially covers or encloses one end of the opening of the clip channel 42. In some embodiments, the clip channel 42 can have an inner axial tab 36 located at the rotor side edge 26 which partially or completely covers a second end of the opening of the clip channel 42. In some embodiments, a front tab 41 and an inner axial tab 36 can be present and can form a pocket 43 between the front tab 41, the inner axial tab 36, the guide anchor top 45, the side tab 37 and the channel side tab 39. In some embodiments, the pocket 43 can be configured to receive a guide 28 of a brake pad carrier 11 with one or more of the front tab 41, inner axial tab 36, channel side tab 39, and side tab 37 contacting a front 49, inner axial 50, channel side 51 and side 46 face of the guide 28, respectively.

As shown in FIG. 2, brake clip 16 can have a return spring 33 extending from or attached to the rotor side edge 26 of brake clip 16. In some embodiments, the return spring 33 can extend from or be attached to the rotor side edge 26 of the clip channel 42. In some embodiments, the return spring 33 can extend from or be attached to the rotor side edge 26 of the clip base 31 or the channel side tab 39 or the pad tensioner 40.

The return spring can be connected to the clip channel 42 by way of a stress-reducing shape at one end, such as a curved section of material that allows the stress associated with the brake pad moving against the return spring 33 and loading the return spring to be distributed over a longer section of material than a sharp corner would provide. However, in other embodiments, a sharp corner between the clip channel 42 and the return spring 33 can be effectively used or a combination of a sharp corner and a rounded section can be effectively used.

The return spring 33 can include a brake pad contactor 29 at an end opposite the connection to the clip channel 42. The brake pad contactor 29 can be configured for sliding or non-sliding contact with the brake pad 12 or brake pad backing plate 48. Examples of a sliding contact include, but are not limited to, a rounded or curved portion, such as a ball or oval end or a backward curving portion of the return spring 33, at the point of contact with the brake pad that can slide along the brake pad 12 or brake pad backing plate 48 as the brake pad moves against return spring 33 and loads spring energy into return spring 33. Additional sliding shapes can include an edge, either sharp or blunt, placed at an angle to the brake pad that allows the end of the return spring to move along the brake pad 23 as the brake pad moves against the return spring 22 and loads spring energy into return spring 33.

In some embodiments, the spring energy is stored into return spring 33 by at least a portion of return spring 33 bending as a lever, whether straight or curved, in response to the movement of the brake pad 12. In some embodiments, bending as a lever can include a substantial portion of the return spring 33 remaining substantially straight or a substantial portion of the return spring 33 curving. In some embodiments, substantial portions of the return spring 33 remain straight while another substantial portion curves. In some embodiments, the spring energy can be stored by way of at least a portion of the return spring bending away from the clip base 31 or the channel side tab 39 or the pad tensioner 40. In some embodiments, the spring energy can be stored by way of at least a portion of the return spring bending toward the clip base 31 or the channel side tab 39 or the pad tensioner 40.

In some embodiments, such as that shown in FIG. 2, the return spring 33 can comprise a flat portion with a rounded connector 30 at one end which connects to the clip base 31, and a rounded brake pad contactor 29 at the opposite end which interacts with the brake pad 12 during operation.

In some embodiments, the brake clip 16 can include retainers to assist in affixing the brake clip 16 to the brake pad carrier 11. Retainers can include, but are not limited to, reverse pointing tabs that can be configured and positioned to bite into or to increase friction when a force is applied to brake clip 16 to remove the brake clip 16 from the brake pad carrier 11. In some embodiments, a retainer can be a radial retainer 38 present on side tab 37. Suitable radial retainers 38, such as that shown in FIG. 2 can extend inwardly (such as toward guide 28, when installed on brake pad carrier 11) and can be angled toward the guide anchor top 45 or the top of the guide 28 such that an effort to remove the U-shaped body 44 from guide 28 increases the force necessary to remove the U-shaped body 44 from the guide 28. In some embodiments, the radial retainer 38 can have a configuration that acts as a barb that resists removal of the U-shaped body 44 from the guide 28. In various embodiments, one or more radial retainers can be located on side tab 37. In some embodiments, a radial retainer 38 can be located at one or both edges of side tab 37. In some embodiments, one or more radial retainer 38 can be located in a central portion of side tab 37. In some embodiments, a side tab 37 can include one or more radial retainers 38 located in a central portion of the side tab 37 and one or more radial retainers 38 located at one or both edges of side tab 37.

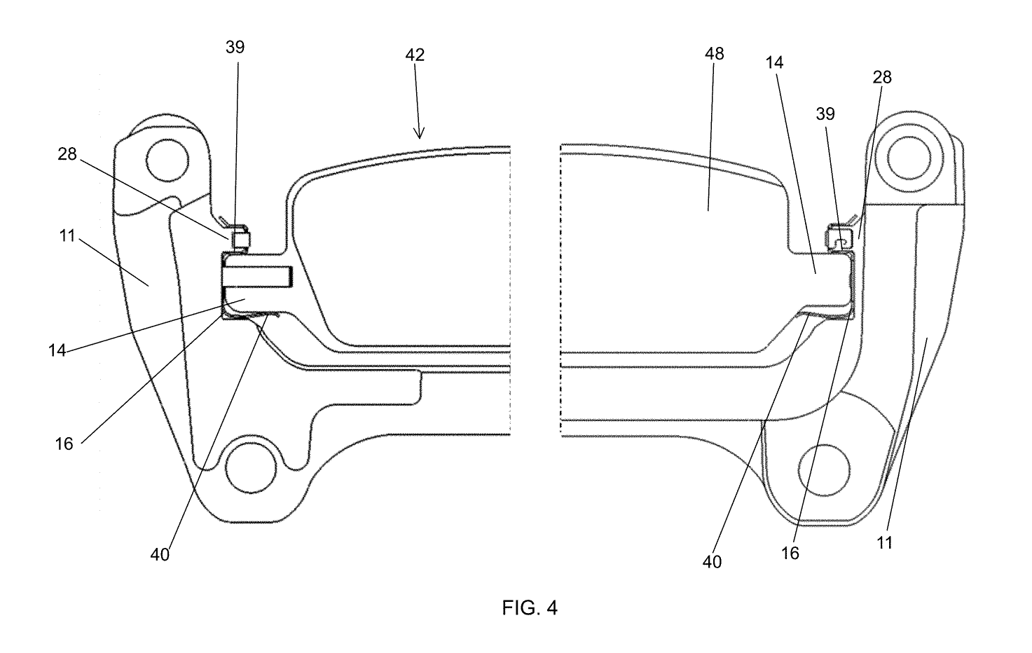

In some embodiments, the front tab 41 can include an outer axial retainer 35. Suitable outer axial retainer 35, such as that shown in FIG. 3 can extend inwardly (such as toward guide 28, when installed on brake pad carrier 11) and can be angled toward the guide anchor top 45 or the top of the guide 28 such that an effort to remove the U-shaped body 44 from guide 28 increases the force necessary to remove the U-shaped body 44 from the guide 28. In some embodiments, the outer axial retainer 35 can have a configuration that acts as a barb that resists removal of the U-shaped body 44 from the guide 28. In various embodiments, one or more outer axial retainer 35 can be located on front tab 41. In some embodiments, an outer axial retainer 35 can be located at one or both edges of front tab 41. In some embodiments, one or more outer axial retainers 35 can be located in a central portion of front tab 41. In some embodiments, a front tab 41 can include one or more outer axial retainers 35 located in a central portion of the front tab 41 and one or more outer axial retainers 35 located at one or both edges of front tab 41.

In some embodiments, one or more of the front tab 41, side tab 37, channel side tab 39 and inner axial tab 36 can comprise a curved region or an angular bend configured, for example, to expand the opening through which the guide 28 is received. In some embodiments, the curved region or angular bend can create a spring tension point 47 (or line or surface, collectively “point”) for closing on the guide 28 to assist in gripping the guide 28. In some embodiments, one or more of the front tab 41, side tab 37, channel side tab 39 and inner axial tab 36 can have a spring tension point 47 at a point on the respective tab at a point distal the guide anchor top 45 in a central portion of the respective tab or at an end of the respective tab, with the location for each tab being independently determined.

In some embodiments, the clip channel 42 can comprise a stop tab 32 configured to retain a brake pad 12 or a portion thereof, such as an ear 14 of brake pad backing plate 48, within the clip channel 42. In some embodiments, the stop tab 32 can retain the brake pad 12 or portion thereof between the stop tab 32 and a return spring 33. In some embodiments, the stop tab 32 can hold a brake pad 12 against return spring 33. As shown in FIG. 2, stop tab can extend from clip base 31 upwardly, either normal to the clip base 31 or angled toward return spring 33. In other embodiments, stop tab 32 can extend from channel side tab 39 or pad tensioner 40 into the clip channel 42. In some embodiments, stop tab 32 can extend normal to the channel side tab 39 or pad tensioner 40 or it can extend angled toward return spring 33. In some embodiments, stop tab 32 can comprise a tab, such as a spring tab, that can deform against brake pad 12. In some embodiments, a brake pad 12 can be held in place in the brake pad carrier 11 by way of being grasped one or more brake clip 16 while the brake pad carrier 11 is separated from the brake caliper and/or while the brake pad carrier 11 is positioned in the brake caliper. In some embodiments, the brake pad 12 can be grasped between the stop tab 32 and the return spring 33 while the brake clip 16 is positioned in the brake pad carrier. Such a feature of the brake pad 12 being held in place in the brake pad carrier 11 can be desirable for assembling brake systems and in servicing brake systems.

In some embodiments, pad tensioner 40 can comprise a curved section that can be configured to exert a spring force against an ear 14 of brake pad 12. In some embodiments, pad tensioner 40 can comprise a straight or an angled section that can be configured to exert a spring force against an ear 14 of brake pad 12. FIG. 4, on the left, shows an embodiment of an ear 14 and pad tensioner 40 where the pad tensioner pushes against a straight or substantially straight portion of ear 14, where the surface of the ear 14 contacted by the pad tensioner 40 is normal or substantially normal to a channel 15 in pad carrier 11, or clip base 31. The pad tensioner pushes against ear 14 to force ear 14 against channel side tab 39. In some embodiments, the spring force applied by pad tensioner 40 to hold the ear 14 against channel side tab 39 can reduce the possibility or occurrence of rattling by brake parts, such as the brake pad 12 in the brake pad carrier 11.

FIG. 4, on the right, shows an embodiment of an ear 14 and pad tensioner 40 where the pad tensioner pushes against an angled of ear 14 where the surface of the ear 14 contacted by the pad tensioner 40 is angled in relation to the channel 15 in pad carrier 11 or clip base 31. The pad tensioner pushes against ear 14 to force ear 14 against channel side tab 39. In some embodiments, the spring force applied by pad tensioner 40 to hold the ear 14 against channel side tab 39 can reduce the possibility or occurrence of rattling by brake parts, such as the brake pad 12 in the brake pad carrier 11.

In various embodiments, the pad carrier 11 can be made by casting, machining or a combination of casting and machining. In some embodiments, the channel 15 can be cast. However, in preferred embodiments, the channel 15 will have a machined surface to improve the fit of the brake clip 16 into the channel 15. In some embodiments, the guide 28 can be cast as a part of the brake pad carrier 11. However, in preferred embodiments, one or more of the surfaces of the guide 28 can be machined, such as the surface at the rotor side edge 26, or the surface opposite the rotor side edge 26, or the top of the guide 28 (which would be associated with the guide anchor top 45) or the side associated with the side tab 37 or the side associated with the channel side tab 39. In some embodiments, the surface at the rotor side edge 26 of guide 28 can be machined while the opposite surface is left in an “as cast” condition or with a brushed surface. In some embodiments, surfaces that will interact with retainers can be left in an “as cast” condition or can have a brushed surface, each surface determined independently, to modify or increase the grip of the retainer on the surface which can be rougher than a machined surface.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims.

Use of language such as “about”, “approximately”, “substantially” are intended to carry the meaning as understood by a person of skill in the art in the context presented where small changes can occur to the numerical value so described which do not change the functioning of the device, unless the context implies a more specific value. In situations where a person of skill would require further guidance, a variation of 5% would be intended.

1. A brake clip comprising:
a U-shaped body;
a clip channel; and
a return spring,
wherein the U-shaped body comprises:
a guide anchor top;
a side tab;
a front tab;
an inner axial tab;
a channel side tab; and
an inner axial tab, and the side tab, front tab, inner axial tab and channel side tab extend from respective edges of the guide anchor top, forming a pocket;
the clip channel defined by:
a clip base comprising a stop tab;
a pad tensioner; and
the channel side tab;
wherein,
the clip base is connected to the pad tensioner and the channel side tab to form a channel;
the return spring is connected to the clip channel at a rotor side edge of the clip channel and extends over the clip base;
the pocket is configured to receive a guide of a brake pad carrier with the front tab, inner axial tab, channel side tab, and side tab contacting a front, inner axial, channel side and side face of the guide, respectively;
the clip channel is configured to fit into a channel on the brake pad carrier and to receive a brake pad; and
the stop tab extends into the clip channel and is configured to press on a brake pad backing plate when a portion of the brake pad backing plate is located in the clip channel.

2. The brake clip of claim 1, wherein the return spring is connected to the clip channel at a proximal end of the return spring, and the distal end of the return spring extends over the clip channel to contact a brake pad backing plate that extends into the clip channel.

3. The brake clip of claim 1, wherein the front tab comprises an outer axial retainer configured to resist removal of the U-shaped body from the guide after the guide is received into the pocket.

4. The brake clip of claim 1, wherein the side tab comprises a radial retainer configured to resist removal of the U-shaped body from the guide after the guide is received into the pocket.

5. The brake clip of claim 1, wherein the inner axial tab is configured to push against the guide to force the front face against the front tab when the guide is received into the pocket.

6. The brake clip of claim 1, wherein the stop tab is configured to retain a brake pad backing plate between the stop tab and the return spring when a portion of the brake pad backing plate is located in the clip channel.

7. A disk brake assembly comprising:
the brake clip of claim 1;
a brake pad carrier comprising the channel and the guide; and
a brake pad comprising the backing plate,
wherein the clip channel is present in the channel, and the guide is present in the pocket, and the return spring contacts the backing plate,
wherein, upon actuation of the brake assembly, the brake pad moves within the channel against the return spring, the return spring providing a restoring force against the brake pad upon deactuation of the brake assembly to assist in moving the brake pad away from the rotor-edge of the clip channel.

8. The disk brake assembly of claim 7, wherein the clip base comprises a stop tab extending in a direction normal to the clip base and the stop tab presses on the brake pad backing plate when the brake pad backing plate is located in the clip channel and the disk brake assembly is deactuated.

9. A brake clip comprising:
a pad tensioner attached to a clip base attached at an edge to a pad tensioner and at an opposite edge to channel side tab to form a clip channel;
a guide anchor top attached at an edge to the channel side tab and at an opposite edge to a side tab to form a U-shaped body extending from a rotor side edge to an outer edge;
a return spring extending from a rotor side edge of the clip channel over the clip base; and
a stop tab extending from the clip base into the clip channel.

10. The brake clip of claim 9, wherein the return spring extends from a rotor side edge of the clip base.

11. The brake clip of claim 9, wherein the return spring comprises a flat spring and a distal end spaced apart from the rotor side edge, the distal end having a rounded end.

12. The brake clip of claim 9, wherein the return spring is configured to contact a brake pad extending into the U-shaped body and in operation, to bend upon movement of the brake pad toward a rotor.

13. The brake clip of claim 9 further comprising a stop tab, the stop tab located at an edge of the clip base and configured to contact a brake pad extending into the clip channel while the return spring contacts the brake pad extending into the clip channel.

14. The brake clip of claim 9, further comprising a front tab, the front tab extending from the guide anchor top to at least partially close one end of the clip channel at the outer edge.

15. The brake clip of claim 9 further comprising an inner axial tab, the inner axial tab extending from the guide anchor top to at least partially close an end of the clip channel at the rotor side edge.

16. The brake clip of claim 12, wherein the return spring comprises a rounded surface where the return spring contacts the brake pad, and the return spring is configured for the rounded surface in operation to slide along the brake pad when the brake pad moves toward the rotor.

17. A brake assembly comprising
the brake clip of claim 9;
a brake pad carrier comprising a first channel and a first guide; and
a first brake pad comprising a first backing plate,
wherein the clip channel for the brake clip is present in the first channel, and the first guide is present in the clip channel of the brake clip, and the return spring of the brake clip contacts the backing plate,
wherein, upon actuation of the brake assembly, the first brake pad moves within the clip channel of the first brake clip against the return spring of the first brake clip, the return spring of the first brake clip providing a restoring force against the first brake pad upon deactuation of the brake assembly to assist in moving the first brake pad away from the rotor-edge of the U-shaped body of the first brake clip.

18. The brake assembly of claim 17 further comprising:
a second brake pad comprising a second backing plate;
a second, third and fourth brake clip, each each being the brake clip of claim 8;
wherein the brake pad carrier comprises a first arm and a second arm, each arm having a first brake abutment position and a second abutment position,
the first brake abutment position of the first arm comprising: the first channel and the first guide;
the second brake abutment position of the first arm comprising: a second channel and a second guide;
the first brake abutment position of the second arm comprising: a third channel and a third guide; and
the brake abutment position of the second arm comprising: a fourth channel and a fourth guide;
wherein, the U-shaped body for the second brake clip is present in the second channel, and the second guide is present in the clip channel of the second brake clip, and the return spring of the second brake clip contacts the backing plate of the first brake pad;
U-shaped body for the third brake clip is present in the third channel, and the third guide is present in the clip channel of the third brake clip, and the return spring of the third brake clip contacts the second backing plate; and
U-shaped body for the fourth brake clip is present in the fourth channel, and the fourth guide is present in the clip channel of the fourth brake clip, and the return spring of the fourth brake clip contacts the second backing plate;
wherein, upon actuation of the brake assembly, the first brake pad moves within the U-shaped bodies of the first and second brake clips against the return springs of the first and second brake clips, the return springs of the first and second brake clips providing a restoring force against the first brake pad upon deactuation of the brake assembly to assist in moving the first brake pad away from the rotor-edge of the U-shaped bodies of the first and second brake clips, and
the second brake pad moves within the U-shaped bodies of the third and fourth brake clips against the return springs of the third and fourth brake clips, the return springs of the third and fourth brake clips providing a restoring force against the second brake pad upon deactuation of the brake assembly to assist in moving the second brake pad away from the rotor-edge of the U-shaped bodies of the third and fourth brake clips.

19. A brake clip comprising:
a brake clip base;
a stop tab extending from the brake clip base; and
a brake pad return spring, the brake pad return spring comprising:
a proximal end attached to an edge of the brake clip base, the edge of the brake pad base when installed is proximate a brake rotor; and
a distal end extended over the brake clip base,
wherein when the brake clip is installed in a brake system, the distal end is configured to contact and exert a force against a brake pad and the stop tab is configured to contact the brake pad.

20. A brake kit comprising:
four brake clips of claim 9;
two brake pads, each brake pad comprising first and second ends, wherein each of the first and second ends are sized and configured to fit into the clip channel of at least one of the four brake clips.
